(19) United States
(12) Patent Application Publication
(10) Pub. No.: US 2020/0328395 A1
(43) Pub. Date: Oct. 15, 2020

(54) ELECTRIC-SHOCK-PROTECTED BATTERY CONNECTOR, BATTERY MODULE AND SYSTEM COMPRISING BATTERY CONNECTORS AND BATTERY MODULES

(71) Applicant: Dr. Ing. h.c. F. Porsche Aktiengesellschaft, Stuttgart (DE)

(72) Inventors: Philipp Trautmann, Stuttgart (DE); Marcus Zacher, Sindelfingen (DE)

(21) Appl. No.: 16/846,740

(22) Filed: Apr. 13, 2020

(30) Foreign Application Priority Data
Apr. 12, 2019 (DE) 10 2019 109 725.8

(51) Int. Cl. H01M 2/20; H01M 2/06; H01M 2/30; H01R 25/16

(52) U.S. Cl. CPC H01M 2/206; H01M 2/06; H01M 2220/20; H01R 25/161; H01M 2/30

(57) ABSTRACT

A battery connector (1) is provided for electrically contact-connecting a first pole pin (19) of a first battery module (10) to a second pole pin (20) of a second battery module (10′). The battery connector (1) has a busbar (1′) with a first contact region (2), a second contact region (3) and a connecting region (4) arranged between the first contact region (2) and the second contact region (3) in a main direction of extent (H) of the busbar (1′). The connecting region (4) has an electrically insulating coating. The first contact region (2) and the second contact region (3) each have a cutout (5). The cutouts (5) are open in an insertion direction (E) that is parallel to a main plane of extent (HE) of the busbar (1′) and orthogonal to the main direction of extent (H).

### CROSS REFERENCE TO RELATED APPLICATION

This application claims priority under 35 USC 119 to German Patent Appl. No. 10 2019 109 725.8 filed on Apr. 12, 2019, the entire disclosure of which is incorporated herein by reference.

### BACKGROUND

### Field of the Invention

The invention relates to a battery connector for electrically contact-connecting a first pole pin of a first battery module to a second pole pin of a second battery module, to a battery module, to a system having at least two battery modules and one battery connector, and also to a motor vehicle having a system comprising at least two battery modules and one battery connector.

### Related Art

When constructing electric vehicles, the high-voltage batteries required are often installed as underfloor batteries. This means that the batteries are arranged in the floor of the vehicle, this being accompanied by considerable limitations in respect of the possible structural height of the batteries. High-voltage batteries are generally of modular construction. This means that individual cell or battery modules have to be connected to one another in order to reach the required voltage and capacitance. At present, the trend is for ever larger battery modules, this leading to the voltage of an individual battery module being above the legally permissible electric-shock-protected voltage. As a result, high-voltage terminals, that is to say connecting points for module connection of the battery modules, have to be of electric-shock-protected design. Electric-shock-protected high voltage terminals of this kind usually protrude far beyond the battery cells and therefore increase the required installation space for the battery modules.

Against this background, the object is to provide a battery connector, battery modules, a system comprising battery modules and battery connectors and also a motor vehicle, which do not exhibit the disadvantages of the prior art but rather provide electric-shock protection with low requirements in respect of installation space height.

### SUMMARY

The invention relates to a battery connector for electrically contact-connecting a first pole pin of a first battery module to a second pole pin of a second battery module. The battery connector has a busbar with a first contact region, a second contact region and a connecting region arranged between the first contact region and the second contact region in a main direction of extent of the busbar. The connecting region has an electrically insulating coating. The first contact region and the second contact region each have a cutout. The cutouts are open in an insertion direction that is parallel to a main plane of extent of the busbar and orthogonal to the main direction of extent.

The battery connector advantageously allows the first battery module and the second battery module to be electrically contact-connected in an electric-shock-protected manner and, in the process, the required installation space height is reduced in comparison to the prior art.

The busbar can have rail-like external dimensions. For example, the busbar can have dimensions in its main plane of extent that are considerably greater than the dimension in the dimension orthogonal to the main plane of extent. Therefore, the busbar can be substantially flat and have an only low height in comparison to its length and width, which are arranged parallel to the main plane of extent. The busbar is manufactured from an electrically conductive material, such as copper, aluminum or soft iron. The connecting region may be coated with an electrically insulating lacquer or surrounded by an electrically insulating plastic casing. It is conceivable for the width of the cutouts parallel to the main direction of extent to be selected such that the pole pins can be readily inserted into the cutouts and fixed in the cutouts.

According to an embodiment of the invention, provision is made for the first contact region and the second contact region to each have a further cutout open in the insertion direction. Thus, the battery connector can be mounted onto more than one pole pin per contact region. As a result, a larger contact area between the battery connector and the battery module is realized so that higher electric current can be conducted. Within the meaning of the present invention, open in the insertion direction means that a pole pin can be inserted into the cutout in the insertion direction. The further cutouts may be dimensioned in the same way as the cutouts.

The cutouts and the further cutouts may be U-shaped. This advantageously ensures that pole pins can be securely and conveniently inserted into the cutouts and into the further cutouts so that secure contact can be made with said pole pins in the cutouts and further cutouts. However, the cutouts and the further cutouts can be C-shaped to provide a design that is shortened in the insertion direction.

The first contact region and the second contact region of certain embodiments have recessed regions that are arranged offset relative to the connecting region in a z-direction that is orthogonal to the main plane of extent. The cutouts and the further cutouts may be in the recessed regions. This design enables a secure fit of the battery connector on the battery modules and a further reduction in the installation space required.

The connecting region may have a thickened portion orthogonal to the main plane of extent. The thickened portion enables a secure grip when inserting and mounting the battery connector in and on the battery modules and also enables centering the battery connector during insertion into the battery modules by a correspondingly configured thinned portion of the battery modules.

The connecting region may have a lug that extends along the insertion direction. Additionally, the lug may extend over the entire extent of the busbar in the insertion direction. The lug is preferably electrically insulating and is suitable for spacing apart the first battery module from the second battery module. The lug further improves guidance during insertion of the battery connector and also ensures an electrically insulating spacing-apart of the first battery module and the second battery module. During operation of the battery modules, it is advantageously possible for heat produced between the battery modules to escape through the space that is created by the spacing-apart operation and for a build-up of heat to be avoided.

The invention also relates to a battery module having an electrically insulating cover arranged along a top side of the battery module. The cover has a first opening and a second opening. The first opening and the second opening are arranged on an edge of the cover. A first covering is arranged over the first opening and a second covering is arranged over the second opening. The first covering is arranged such that a gap with an insertion height is created between the cover and the first covering on that side of the covering that is averted from the edge and between the cover and the first covering on that side of the first covering that is averted from the second covering. The second covering is arranged such that a gap with the insertion height is created between the cover and the second covering on that side of the second covering that is averted from the edge and between the cover and the second covering on that side of the second covering which is averted from the first covering. A first pole pin of the battery module is arranged in the first opening and a second pole pin of the battery module is arranged in the second opening.

The battery module of the invention enables an electrical contact connection to be established between the battery module and a further battery module according to the invention by means of a battery connector, without additional electric-shock protection having to be provided and therefore an increased installation space requirement being created in a direction orthogonal to the top side of the battery module. To this end, it is possible to insert a flat battery connector, which has a thickness of not more than the insertion height in contact areas, into the first opening or into the second opening such that electrical contact can be made with the first pole pin or the second pole pin. In this case, the first covering and the second covering already form electric-shock protection for protecting against the contact areas being touched. The cover may be manufactured from a plastic. Furthermore, the first pole pin and the second pole pin may have a thread for screwing on a nut.

Openings may be provided for receiving a battery connector according to the invention for connection to a pole pin of the battery module. Additionally, the first covering and the second covering may be configured for completely covering the first contact region or the second contact region in a projection onto the top side of the battery module. This feature enables electrical connection of plural battery modules in a manner that saves a large amount of installation space.

The insertion height to may correspond to a thickness that is orthogonal to a main plane of extent of the first contact region and/or of the second contact region, thereby further reducing the required installation space height. As an alternative, provision is made for the insertion height to correspond at most to twice the thickness of the first contact region and/or of the second contact region. More particularly, the insertion height may correspond at most to 1.5 times the thickness of the first contact region and/or of the second contact region, and particularly preferably the insertion height corresponds at most to 1.2 times the thickness of the first contact region and/or of the second contact region. This aspect achieves a flat design and convenient insertion of the battery connector.

The first covering may be at least partially connected to the cover in the region between the cover and the first covering on that side of the first covering that faces the edge and between the cover and the first covering on that side of the first covering that faces the second covering and/or for the second covering may be at least partially connected to the cover in the region between the cover and the second covering on that side of the second covering that faces the edge and between the cover and the second covering on that side of the second covering that faces the first covering. This has the effect that the coverings are connected to the cover in a very stable manner. Mechanical loads that act on the coverings therefore can be diverted advantageously to the cover to avoid damage in the region of the coverings and to assure the safety-related electric-shock protection.

The pole pins may be configured not protrude beyond the cover in a z-direction, which is orthogonal to the top side. Thus, the pole pins are arranged at a distance from the first covering and the second covering in the z-direction, preferably by more than the insertion height. More particularly, the pole pins may be arranged at a distance from the first covering and the second covering in the z-direction by more than 1.5 times the insertion height. A further first pole pin of the battery module may be arranged in the first opening and a further second pole pin of the battery module may be arranged in the second opening. The further pole pins do not protrude beyond the cover in a z-direction, which is orthogonal to the top side. Additionally, the further pole pins may be arranged at a distance from the first covering and the second covering in the z-direction by more than the insertion height. More particularly, the further pole pins may be arranged at a distance from the first covering and the second covering in the z-direction by more than 1.5 times the insertion height. This renders a further simplified and even more convenient insertion of the battery connector. At the same time, the pole pins and the further pole pins are protected against mechanical effects due to the greater distance from the coverings.

A first captive nut may be arranged on the first covering for being screwed onto the first pole pin, and a second captive nut may be arranged on the second covering for being screwed onto the second pole pin. The first captive nut may be suitable for fixedly screwing the cutout of the first contact region or the cutout of the second contact region in the first opening, and the second captive nut may be suitable for fixedly screwing the cutout of the first contact region or the cutout of the second contact region in the second opening. In this way, the pole pins can be contact connected to the contact regions while at the same time securing the fit of the battery connector. Within the meaning of the present invention, captive nut means that the nut has an internal thread for being screwed onto an external thread and also has an additional securing means against becoming lost in the non-screwed-on state. The additional securing means can be, for example, a securing ring that is attached to the nut. The captive nuts can be arranged below a screw opening of the coverings so that direct access to the covering is ensured for screwing-on the captive nuts. The captive nuts may have a cap in which the internal thread ends in the form of a blind hole thread. More particularly, the captive nuts may be cap nuts in accordance with DIN 1587 or DIN 917. In addition, it is conceivable for the cap to have a slot or a driving profile for a crosshead tool or a driving profile for a Torx tool or a driving profile for another screw head drive. It is furthermore conceivable for the captive nuts to have a washer on their end face that is averted from the cap. This allows for a larger contact area between the captive nut and the contact region. Therefore, it is conceivable for the captive nuts to have features of cap nuts in accordance with DIN 1587 and DIN 917 and collar nuts in accordance with DIN 6331. The captive nuts may not have a hexagonal profile on their outer side. The captive nuts may be produced from copper, aluminum, soft iron or another conductive material. Since the captive nuts can be screwed onto the profile pins, a person skilled in the art could also refer to them as captive screws. Within the meaning of the present invention, captive nut and captive screw have the same meaning, configuration and function outlined above.

According to a further preferred embodiment of the invention, provision is made for a further first captive nut for being screwed onto the further first pole pin to be arranged on the first covering, wherein a further second captive nut for being screwed onto the further second pole pin is arranged on the second covering, wherein the further first captive nut is preferably suitable for fixedly screwing the further cutout of the first contact region or the further cutout of the second contact region in the first opening, and the further second captive nut is preferably suitable for fixedly screwing the further cutout of the first contact region or the further cutout of the second contact region in the second opening. This renders possible an even larger contact area for conducting electric current and therefore reducing undesired ohmic resistances. It is conceivable for the further captive nuts to have the same features as the captive nuts.

The cover may have a first thinned portion in a direction orthogonal to the surface at a first corner between the edge and a first further edge that is adjacent to the first covering. The cover also may a second thinned portion in a direction orthogonal to the surface at a second corner between the edge and a second further edge that is adjacent to the second covering. This configuration enables securely guided insertion of the battery connector. The thinned portions may be shaped in a complementary manner to at least a part of the thickened portion of the battery connector. The thinned portions may be shaped in a complementary manner to a part of the thickened portion between the lug and the first contact region or the second contact region of the battery connector.

The invention also relates to a system having a first battery module as described above, a second battery module as described above and a battery connector as described above. The battery connector, by way of the first contact region, is inserted into the first opening of the first battery module, and the battery connector, by way of the second contact region, is inserted into the second opening of the second battery module. The system enables a securely modularly interconnected battery composed of individual battery modules so that the battery exhibits electric-shock protection in spite of having a low structural height.

The first contact region may be electrically contact-connected to the first pole pin of the first battery module at the cutout of the first contact region by means of the first captive nut. Similarly, the second contact region may be electrically contact-connected to the second pole pin of the second battery module at the cutout of the second contact region by means of the second captive nut. The first contact region may be electrically contact-connected to the further first pole pin of the first battery module at the further cutout of the first contact region by means of the further first captive nut. Additionally, the second contact region may be electrically contact-connected to the further second pole pin of the second battery module at the further cutout of the second contact region by means of the further second captive nut. This ensures a secure electrical contact-connection and a secure fit of the battery connector.

The invention also relates to a motor vehicle having the above-described system.

All of the statements made above equally apply to the battery connector, the battery module, the system and the motor vehicle according to the invention.

Further details, features and advantages of the invention can also be found in the drawings and in the following description of preferred embodiments with reference to the drawings. The drawings illustrate only exemplary embodiments of the invention and do not restrict the scope of the invention defined by the claims.

### BRIEF DESCRIPTION OF THE DRAWINGS

FIG. 1 schematically illustrates a system according to an exemplary embodiment of the invention having two battery connectors and two battery modules according to an embodiment of the invention.

FIG. 2 schematically illustrates a battery connector according to an exemplary embodiment of the present invention.

FIG. 3 schematically illustrates a section through a battery module according to an embodiment of the invention with an inserted battery connector according to an embodiment of the present invention.

FIG. 4 schematically illustrates a section through a battery module according to an embodiment of the invention with an inserted battery connector, which is exposed in the drawing, according to an embodiment of the invention.

FIG. 5 schematically illustrates a motor vehicle according to an exemplary embodiment of the invention.

### DETAILED DESCRIPTION

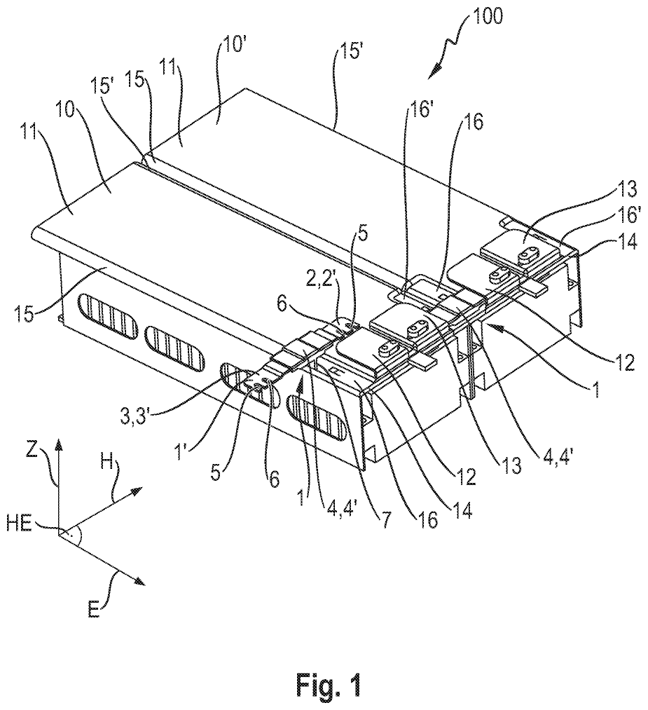

FIG. 1 schematically illustrates a system 100 according to an exemplary embodiment of the present invention having two battery connectors 1 according to an exemplary embodiment of the present invention, the first battery module 10 according to an exemplary embodiment of the present invention and the second battery module 10′ according to an exemplary embodiment of the present invention. The first battery module 10 and the second battery module 10′ each have the cover 11 with the first covering 12, which covers the first opening 17 (not visible here, see FIG. 3), and the second covering 13, which covers the second opening 18. The first coverings 12 have the gaps 18 (not visible here) on their sides which face the respective first further edge 15 and are averted from the respective edge 14, and the second coverings 13 have the gaps 18 (likewise not visible here, see FIG. 3) on their sides which face the respective second further edge 15′ and are averted from the respective edge 14.

To electrically connect the first battery module 10 to the second battery module 10′, a battery connector 1 is inserted into the first opening 17 of the second battery module 10′ and the second opening 18 of the first battery module 10, centrally in the figure. Only the connecting region 4, which is coated with an insulating coating, with the thickened portion 4′ is visible here. The non-electrically-insulated first contact region 2 and the non-electrically-insulated second contact region 3 are covered by the first covering 12 of the second battery module 10′ and, respectively, the second covering 13 of the first battery module 10. Here, the coverings 12, 13 act as an electric-shock protection and prevent, together with the insulating coating of the connecting region 4, a live part from being touched.

FIG. 1 furthermore shows, on the left-hand side, a battery connector 1 which has not yet been inserted. The battery connector 1 has, as can be clearly seen here, the busbar 1′ which is manufactured from an electrically conductive material, preferably copper, aluminum or soft iron. Said figure furthermore shows the regions which are arranged adjacent in the main direction of extent H of the battery connector 1: the second contact region 3, the connecting region 4 and the first contact region 2. The first contact region 2 and the second contact region 3 each have recessed regions 2′, 3′ which are recessed in the z-direction Z. The U-shaped cutouts 5 and the U-shaped further cutouts 6, which are each open in the insertion direction E, are arranged in the recessed regions 2′, 3′. If the battery connector 1 is inserted into the openings 17, 18 of the cover 11, the battery connector 1 is centered by way of the thickened portion 4′ of the connecting region 4 sliding into the first thinned portion 16 or the second thinned portion 16′ of the cover 11. In the inserted state of the battery connector 1, the lug 7 is arranged between the first battery module 10 and the second battery module 10′ and spaces apart said battery modules from one another.

Owing to the flat shape of the busbar 1′ arranged along the main plane of extent HE and the low structural height of the first covering 12 and of the second covering 13, a very flat construction of the system 200 is possible.

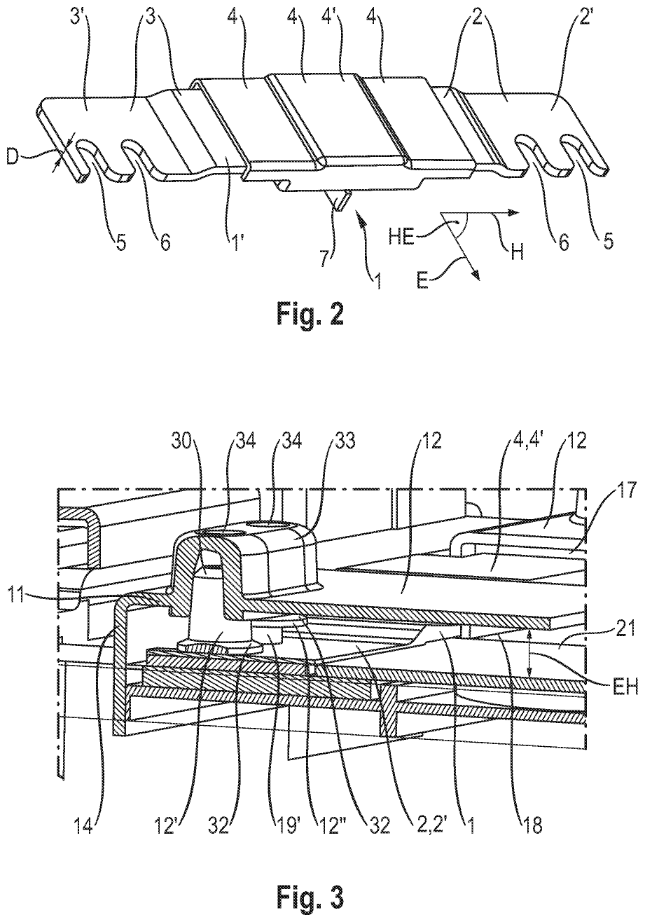

FIG. 2 schematically illustrates a battery connector 1 according to an exemplary embodiment of the present invention. The figure clearly shows the busbar 1′, which is arranged along the main direction of extent H in the main plane of extent HE, with the first contact region 2, the second contact region 3, the insulated connecting region 4, the thickened portion 4′ and the lug 7. The U-shaped cutouts 5 which are open in the insertion direction E and the further U-shaped cutouts 6 which are open in the insertion direction E are arranged in the recessed regions 2′, 3′. The busbar 1′ has the thickness D.

FIG. 3 schematically illustrates a section through a battery module 10 according to an exemplary embodiment of the present invention with an inserted battery connector 1 according to an exemplary embodiment of the present invention. Said figure shows details relating to securing the fit of the battery connector 1 in the second opening 18 and contact-connecting the first contact region 2 to the first pole pin 19 (here hidden by the first captive nut 12′) and the further first pole pin 19′. The first contact region 2 is arranged in the first opening 18 and covered in an electric-shock-protected manner by the first covering 12. The first covering 12 is connected to the cover 11 at the edge 14 as is clearly shown here. In order to position the battery connector 1 in the manner in which it is shown in FIG. 3, said battery connector is inserted through the gap 21 into the first opening 17 until the cutout 5 (not clearly visible here) surrounds the first pole pin 19 and the further cutout 6 (likewise not clearly visible here) surrounds the further first pole pin 19′. In order to save structural height, the insertion height EH of the gap 21 corresponds to 1.2 times the thickness of the busbar 1′ (see FIG. 2). In order to electrically contact-connect and secure the battery connector 1, the first captive nut 12′ and the further first captive nut 12″ are screwed onto the first pole pin 19 and, respectively, the further first pole pin 19′ until the captive nuts 12′, 12″ are fixedly seated on the first contact region 2 by way of a ring 32 which is arranged at the end side which is averted from the cover 11. The captive nuts 12′, 12″ are manufactured from a conductive material and establish the electrical contact between the first pole pin 19, the further first pole pin 19′ and the first contact region 2. The captive nuts 12′, 12″ are secured against becoming lost in the non-fixedly-screwed state by way of being clamped between the cover 11 and the pole pins 19, 19′. To this end, an upper part of the captive nuts 12′, 12″ is located in a nut housing 33 of the cover 11. Overall, the captive nuts 12′, 12″ are so long that they cannot be removed by being lifted away from the pole pins 19, 19′ and tilted and/or moved out of the nut housing 33. For convenient screwing-in, the nut housing 33 has, above the captive nuts 12′, 12″, a respective screw opening 34 for inserting a tool in order to turn the respective captive nut 12′, 12″. For being screwed onto the pole pins 19, 19′, the captive nuts 12′, 12″ are provided with an internal thread, not shown, and the pole pins 19, 19′ are provided with an external thread, not shown.

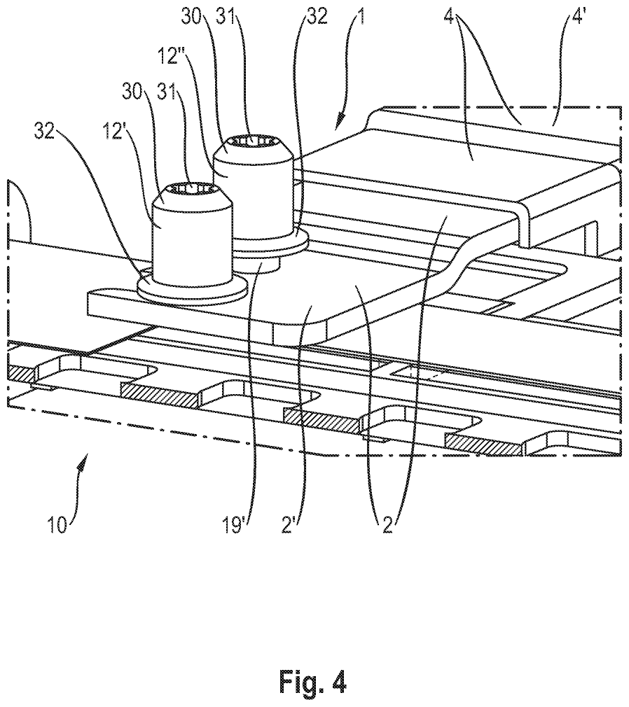

FIG. 4 schematically illustrates a section through a battery module 10 according to an embodiment of the invention with an inserted battery connector 1, which is exposed in the drawing. For reasons of clarity, parts of the battery module 10 that would block the view of the battery connector 1 and in particular of the first contact region 2 have been removed in FIG. 4. FIG. 4 clearly shows the first captive nut 12′ and the second captive nut 12″ that can be screwed onto the first pole pin 19 (hidden by the first captive nut 12′ here) and, respectively, the further pole pin 19′. A cap 30 is arranged on that end side of the captive nuts 12′, 12″ that is averted from the contact region 2. The cap 30 closes the end and has a driving profile 31 for a screw head drive. A ring 32 is arranged on that end of the captive nuts 12′, 12″ that faces the contact region 2. The driving profile 31 ensures convenient screwing of the captive nuts 12′, 12″ onto the first pole pin 19 and the further first pole pin 19′. The rings 32 increase the size of the area over which the electrical contact between the captive nuts 12′, 12″ and the contact region 2 is established.

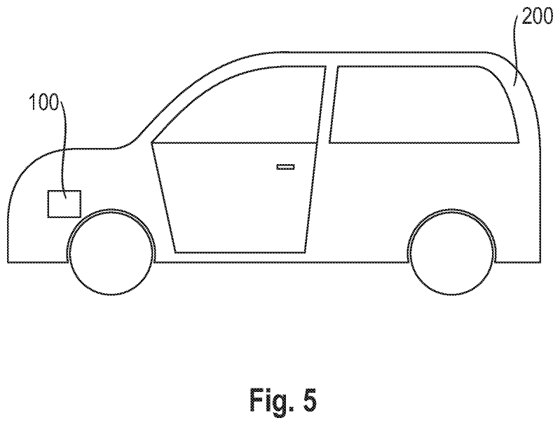

FIG. 5 schematically illustrates a motor vehicle 200 according to an embodiment of the invention. The motor vehicle 200 has the system 100 according to the invention with a large number of battery modules 10 according to the invention and battery connectors 1 that connect the battery modules 10 (see FIG. 1).

What is claimed is:

1. A battery connector for electrically contact-connecting a first pole pin of a first battery module to a second pole pin of a second battery module, the battery connector comprising: a busbar with a first contact region, a second contact region and a connecting region between the first contact region and the second contact region in a main direction of extent of the busbar, the connecting region having an electrically insulating coating, the first contact region and the second contact region being provided respectively with cutouts, wherein the cutouts are open in an insertion direction that is parallel to a main plane of extent of the busbar and orthogonal to the main direction of extent.

2. The battery connector of claim 1, wherein the first contact region and the second contact region each have a further cutout, the further cutouts being open in the insertion direction.

3. The battery connector of claim 2, wherein the cutouts and the further cutouts are U-shaped.

4. The battery connector of claim 2, wherein the first contact region and the second contact region each have a recessed region, the recessed regions being arranged offset relative to the connecting region in a z-direction that is orthogonal to the main plane of extent, the cutouts and the further cutouts being arranged in the recessed regions.

5. The battery connector of claim 1, wherein the connecting region has a thickened portion orthogonal to the main plane of extent.

6. The battery connector of claim 1, wherein the connecting region has a lug that extends over an entire extent of the busbar in the insertion direction, the lug being electrically insulating and spacing apart the first battery module from the second battery module.

7. A battery module comprising: an electrically insulating cover that is arranged along a top side of the battery module, the cover having a first opening and a second opening, the first opening and the second opening being arranged on an edge of the cover, a first covering being arranged over the first opening and a second covering being arranged over the second opening, the first covering being arranged such that a gap with an insertion height is created between the cover and the first covering on a side of the covering that is averted from the edge and between the cover and the first covering on a side of the first covering that is averted from the second covering,
the second covering being arranged such that a gap with the insertion height is created between the cover and the second covering on that side of the second covering that is averted from the edge and between the cover and the second covering on that side of the second covering that is averted from the first covering,
a first pole pin of the battery module being arranged in the first opening and a second pole pin of the battery module being arranged in the second opening.

8. The battery module of claim 7, wherein the openings are configured for receiving a battery connector for connection to a pole pin of the battery module, the battery connector having a busbar with a first contact region, a second contact region and a connecting region between the first contact region and the second contact region in a main direction of extent of the busbar, the connecting region having an electrically insulating coating, the first contact region and the second contact region being provided respectively with cutouts that are open in an insertion direction that is parallel to a main plane of extent of the busbar and orthogonal to the main direction of extent, and the first covering and the second covering each being configured for completely covering the first contact region or the second contact region in a projection onto the top side of the battery module.

9. The battery module of claim 8, wherein the insertion height corresponds to a thickness that is orthogonal to the main plane of extent of the first contact region and/or of the second contact region.

10. The battery module of claim 7, wherein the first covering is at least partially connected to the cover in the region between the cover and the first covering on that side of the first covering that faces the edge and between the cover and the first covering on that side of the first covering that faces the second covering; and
the second covering is at least partially connected to the cover in the region between the cover and the second covering on that side of the second covering that faces the edge and between the cover and the second covering on that side of the second covering that faces the first covering.

11. The battery module of claim 7, wherein the pole pins do not protrude beyond the cover in a z-direction that is orthogonal to the top side, the pole pins being arranged at a distance from the first covering and the second covering in the z-direction by more than the insertion height, wherein a further first pole pin of the battery module is arranged in the first opening and a further second pole pin of the battery module is arranged in the second opening, the further pole pins do not protrude beyond the cover in the z-direction, the further pole pins being arranged at a distance from the first covering and the second covering in the z-direction by more than the insertion height.

12. The battery module of claim 7, further comprising a first captive nut arranged on the first covering and being configured for being screwed onto the first pole pin and a second captive nut arranged on the second covering and being configured for being screwed onto the second pole pin, the first captive nut being configured for fixedly screwing the cutout of the first contact region or the cutout of the second contact region in the first opening, and the second captive nut being configured for fixedly screwing the cutout of the first contact region or the cutout of the second contact region in the second opening.

13. The battery module of claim 12, further comprising a further first captive nut arranged on the first covering and being configured for being screwed onto the further first pole pin, and a further second captive nut arranged on the second covering and being configured for being screwed onto the further second pole pin, the further first captive nut being configured for fixedly screwing the further cutout of the first contact region or the further cutout of the second contact region in the first opening, and the further second captive nut being configured for fixedly screwing the further cutout of the first contact region or the further cutout of the second contact region in the second opening.

14. The battery module of claim 7, wherein the cover has a first thinned portion in a direction orthogonal to the surface at a first corner between the edge and a first further edge that is adjacent to the first covering, and the cover further has a second thinned portion in a direction orthogonal to the surface at a second corner between the edge and a second further edge that is adjacent to the second covering.

15. A system having first and second battery modules in accordance with the battery module of claim 8, wherein the battery connector, by way of the first contact region, is inserted into the first opening of the first battery module, and wherein the battery connector, by way of the second contact region, is inserted into the second opening of the second battery module.

16. The system of claim 15, wherein the first contact region is electrically contact-connected to the first pole pin of the first battery module at the cutout of the first contact region by means of the first captive nut, wherein the second contact region is electrically contact-connected to the second pole pin of the second battery module at the cutout of the second contact region by means of the second captive nut, wherein the first contact region is preferably electrically contact-connected to the further first pole pin of the first battery module at the further cutout of the first contact region by means of the further first captive nut, wherein the second contact region is electrically contact-connected to the further second pole pin of the second battery module at the further cutout of the second contact region by means of the further second captive nut.

17. A motor vehicle having the system of claim 15.
